(19) United States
(12) Patent Application Publication
(10) Pub. No.: US 2020/0116405 A1
(43) Pub. Date: Apr. 16, 2020

(54) MANUALLY ADJUSTABLE THERMAL EXPANSION VALVE ATTACHMENT SYSTEMS

(71) Applicant: Ian Calvert, Chandler, AZ (US)

(72) Inventor: Ian Calvert, Chandler, AZ (US)

(21) Appl. No.: 16/654,985

(22) Filed: Oct. 16, 2019

Related U.S. Application Data
(60) Provisional application No. 62/746,515, filed on Oct. 16, 2018.

(51) Int. Cl. F25B 49/02; F25B 41/06; F25B 41/04; F16K 31/60

(52) U.S. Cl. CPC F25B 49/022; F25B 41/062; F25B 2400/077; F16K 31/605; F25B 41/04

(57) ABSTRACT

A manually adjustable thermal expansion valve attachment provides a modular repair assembly useful for replacing the expansion bulb or motorhead of a thermal expansion valve in a refrigeration system with a manually adjustable actuator. The attachment is useful for converting a traditionally constructed thermal expansion valve to a manually adjusted valve. In additional, the attachment is useful for quickly and easily repairing a malfunctioning thermal expansion valve by replacing a damaged expansion bulb or motorhead with the manually adjustable attachment. This is advantageous because the disclosed attachment does not require installation, modification, or manipulation of any external conduits or mechanisms to install, as is the case with the traditional expansion bulb. By simply replacing the defective expansion bulb with the disclosed attachment, a user may return the valve to an operating condition without risk of stressing a downstream compressor.

### CROSS REFERENCE TO RELATED APPLICATION

The present application is related to and claims priority to U.S. Provisional Patent Application No. 62/746,515 filed Oct. 16, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of air conditioning and refrigeration and more specifically relates to attachments for thermal expansion valves.

### 2. Description of Related Art

Thermal expansion valves are a vital component in refrigeration systems for metering the flow of refrigerant into the evaporator, thereby controlling superheat. Thermal expansion valves include a temperature sensing device which opens the valve further in response to heat. Often this is accomplished by the use of a thermal expansion bulb which expands when heated and pushes upon the thermal expansion valve to gradually open it. Generally, the thermal expansion bulb is connected to the evaporator by a conduit so that the bulb will respond to the evaporator's internal pressure, temperature, or both. The valve is calibrated such that the evaporator side of the system maintains a much lower pressure than the condenser side of the system. This balance is necessary for reliability and efficiency.

However, while the thermal expansion bulb is responsible for safely regulating the flow of refrigerant, it is often the least reliable component of the valve system. If the bulb is defective, the refrigeration system may experience localized refrigerant starvation, high superheats, and overworking of the compressor. Compressor failure is a common result of a defective thermal expansion valve. Compressor replacement is a costly repair. A suitable solution is desired.

U.S. Pat. No. 3,486,734 to Madden T Works relates to a valve. The described valve includes a valve stem which is provided with standard acme threads of relatively coarse pitch for receiving the internal threads of a drive nut structure. The drive nut is rotatably journaled within an operator housing carried by the valve body and is mechanically rotated to impart longitudinal movement to the valve stem. The valve stem is also provided with fine-pitch threads which are formed on the crests of the acme threads in opposite relation to the pitch of the acme threads. A stop member is provided with fine internal threads which receive the fine-pitch external threads on the valve stem. The stem stop member is provided with a locking mechanism allowing limited rotation of the stop member relative to the valve stem. This limited movement effectively aids in both engaging and disengaging of the stop member relative to the drive nut structure of the valve as the gate is moved to or from its lowermost position, but it is not absolutely necessary.

### BRIEF SUMMARY OF THE INVENTION

In view of the foregoing disadvantages inherent in the known air conditioning and refrigeration art, the present disclosure provides a novel manually adjustable thermal expansion valve attachment system. The general purpose of the present disclosure, which will be described subsequently in greater detail, is to effectively replace a damaged expansion bulb in a thermal expansion valve to restore functionality and reliability to a refrigeration system.

A manually adjustable thermal expansion valve attachment system is disclosed herein. The manually adjustable thermal expansion valve attachment system includes an assembly comprising a valve head configured to attach to an existing thermal expansion valve, in place of an expansion bulb head, a set screw threaded centrally into said valve head, a lock nut threaded externally onto said set screw, and a sealing washer configured to seal said set screw to said valve head. A valve depressor adaptor is further included which may include a stainless steel material or other suitable material. The valve depressor adaptor may be flat and have a small center hole similar to a washer. It may or may not attach to the set screw of the assembly. The purpose of the valve depressor adaptor is to accommodate thermal expansion valves with 2 or more valve depressing pins/rods. The centered set screw can now depress multiple pins or remove the adaptor to depress a single pin thermal expansion valve.

The valve head comprises a hexagonal collar and an interior threaded cylinder configured to engage a thread of the thermal expansion valve. The valve head includes a threaded aperture concentric to the threaded cylinder. The set screw is disposed in the aperture and threads in and out within the assembly. In one embodiment, the set screw comprises #10-32 threading. The sealing washer has a circular profile and a center aperture. The sealing washer sits between the lock nut and the valve head, such that the sealing washer compresses around the set screw and seals the assembly. The sealing washer comprises an external lock ring having traction appendages for applying friction to or deforming against both the valve head and the lock nut. In other embodiments, the sealing washer does not comprise traction appendages. The sealing washer may further comprise a sealing-portion disposed interior to the external lock ring. The sealing-portion comprises a deformable material such that when compressed, the sealing portion deforms to the valve head and the set screw to prevent fluid from leaving the thermal expansion valve upon which the assembly is installed. The sealing washer may comprise a softer metal material or other deformable material such as but not limited to Teflon, PVC, or rubber.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a manually adjustable thermal expansion valve attachment systems, constructed and operative according to the teachings of the present disclosure.

FIG. 1A is a top view of a sealing washer of the manually adjustable thermal expansion valve attachment system according to an embodiment of the disclosure.

FIG. 1B is a perspective view of the sealing washer of the manually adjustable thermal expansion valve attachment system according to an embodiment of the disclosure.

FIG. 1C is a side view of the sealing washer of the manually adjustable thermal expansion valve attachment system according to an embodiment of the disclosure.

FIG. 2A is a perspective view of an alternative embodiment of the sealing washer of the manually adjustable thermal expansion valve attachment system.

FIG. 2B is a side view of an alternative embodiment of the sealing washer of the manually adjustable thermal expansion valve attachment system.

FIG. 2C is a top view of an alternative embodiment of the sealing washer of the manually adjustable thermal expansion valve attachment system.

FIG. 3A is a perspective view of a set screw of the manually adjustable thermal expansion valve attachment system according to an embodiment of the present invention.

FIG. 3B is a perspective view of the set screw of the manually adjustable thermal expansion valve attachment system according to an embodiment of the present invention.

FIG. 3C is a side view of the set screw of the manually adjustable thermal expansion valve attachment system according to an embodiment of the present invention.

FIG. 4A is a perspective view of a lock nut of the manually adjustable thermal expansion valve attachment system.

FIG. 4B is a side view of the lock nut of the manually adjustable thermal expansion valve attachment system according to an embodiment of the disclosure.

FIG. 4C is a front face view of the lock nut of the manually adjustable thermal expansion valve attachment system according to an embodiment of the disclosure.

FIG. 5 is a perspective view of the manually adjustable thermal expansion valve attachment system including an assembly according to an embodiment of the disclosure.

FIG. 6A is a front perspective view of the assembly according to an embodiment of the disclosure.

FIG. 6B is a side view of the assembly according to an embodiment of the disclosure.

FIG. 6C is a front perspective view of the assembly according to an embodiment of the present invention.

The various embodiments of the present invention will hereinafter be described in conjunction with the appended drawings, wherein like designations denote like elements.

### DETAILED DESCRIPTION

As discussed above, embodiments of the present disclosure relate to a plumbing and more particularly to a manually adjustable thermal expansion valve attachment systems as used to improve the attachments for thermal expansion valves.

Generally, the manually adjustable thermal expansion valve attachment provides a service replacement part used by HVAC technicians. After placing the attachment on a failed thermal expansion valve, the technician can make adjustments to the refrigerant flow by making small adjustments to a set screw of the invention via an Allen wrench or hex-head bit. The attachment is useful for converting a traditionally constructed thermal expansion valve to a manually adjusted valve. In additional, the attachment is useful for quickly and easily repairing a malfunctioning thermal expansion valve by replacing a damaged expansion bulb or motorhead with the manually adjustable attachment. This is advantageous because the disclosed attachment does not require installation, modification, or manipulation of any external conduits or mechanisms to install, as is the case with the traditional expansion bulb. By simply replacing the defective expansion bulb with the disclosed attachment, a user may quickly and easily return the valve to an operating condition without risk of stressing the compressor or other components of the system. A user may install the attachment as a temporary measure. Because the manually adjustable attachment does not include an expansion bulb, it is not prone to the same failures as a traditional thermal expansion valve. In accordance with this application, some dimensions of the attachment, and particularly the threaded portion engaging the thermal expansion valve, may be structured similarly to a thermal expansion bulb in order to be able to fasten to the thermal expansion valve body and sufficiently engage the thermal expansion valve within the valve body.

The device may be used as a temporary fix for accurately metering refrigerant as to avoid compressor failure by flooding. The device may be composed in 4-5 parts. The attachment includes an assembly including a valve head, a set screw which may include a bolt, toggle, or screw, a seal, and a lock nut which locks the screw set in a fixed position. Preferably, the valve head has a hexagonal collar and an interior threaded cylinder able to engage a 11/16″ thread of the thermal expansion valve. The valve head may include an additional aperture concentric to the threaded cylinder having a #10-32 thread. The set screw may be disposed in this aperture, such that it may be adjusted to threadably advance or regress the screw within the assembly. In use, this screw engages the internal valve of the thermal expansion valve, replacing the automated action of the expansion bulb or motorhead. A lock nut engages the same #10-32 threading of the set screw to lock the set screw in position against the valve head. The seal may be a rubber O-ring or similar type of seal able to seal the set screw to the valve head.

In one embodiment of the present invention, the manually adjustable thermal expansion valve attachment systems may include a valve head, a set screw, a sealing washer designed to prevent leaks of refrigerant from the set screw area, and a lock nut which is typically hex shaped however, additional shapes may be used. The valve head may be able to attach to the threads of an existing thermal expansion valve, replacing an expansion bulb head. The threaded sections may vary in size. The set screw may be threaded centrally into the valve head, and the lock nut threaded externally to the set screw. The set screw may be turned to advance or retard its reach down into the valve body and press against the thermal expansion valve. The lock nut may be tightened down against the valve head to prevent free movement of the set screw once a desired adjustment has been made. The sealing washer may be placed between the lock nut and the valve head, such that it compresses around the set screw and seals the assembly. The sealing washer may be reusable or one-time useable. The lock nut may comprise a copper, brass, aluminum, steel, stainless steal, titanium, or other suitable material. The lock nut may be removeable.

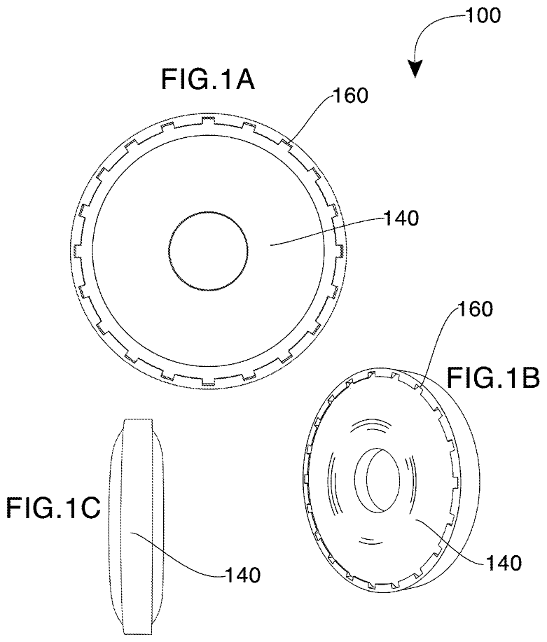

Referring now more specifically to the drawings by numerals of reference, there is shown in FIGS. 1A-5C, various views of a manually adjustable thermal expansion valve attachment system 100. FIGS. 1A-1C show various views of a manually adjustable thermal expansion valve attachment system 100, according to an embodiment of the present disclosure. As illustrated, the manually adjustable thermal expansion valve attachment system 100 may include an assembly 110 comprising a valve head 112 configured to attach to an existing thermal expansion valve, in place of an expansion bulb head, a set screw 120 threaded centrally into the valve head 112, a lock nut 130 threaded externally onto the set screw 120, a sealing washer 140 configured to seal the set screw 120 to the valve head 112 and a valve depressor adaptor 170 including a stainless steel oversized washer. As shown in FIGS. 1A-1C, the sealing washer 140 may be circular in shape and have an aperture to allow the set screw 120 to pass through it. The sealing washer 140 may include an external lock ring having traction appendages 160 for applying friction to or deforming against both the valve head 112 and the lock nut 130. As the sealing washer 140 is compressed between the lock nut 130 and the valve head 112, these traction appendages 160 may deform and apply pressure to the lock nut 130 and the valve head 112. In addition, these traction appendages 160 may dig into the lock nut 130 and the valve head 112. This functionally may discourage the lock nut 130 from loosening from the valve head 112.

As illustrated, the sealing washer 140 also includes a sealing portion 142 disposed interior to the external lock ring. This sealing portion 142 may be constructed of rubber or another deformable material. When compressed, the sealing portion 142 may deform to the valve head 112 and the set screw 120 to prevent any fluid from leaving the thermal expansion valve upon which the assembly 110 is installed. In one embodiment, the external diameter of the sealing washer 140 may be four-hundred and forty-three thousandths of an inch, while the diameter of the aperture may measure eighteen hundredths of an inch.

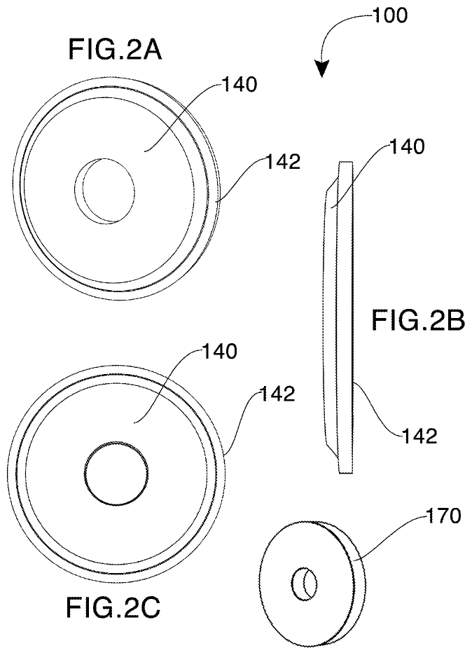

FIGS. 2A-2C show a perspective views of an alternative embodiment of the sealing washer 140 of the manually adjustable thermal expansion valve attachment system 100, according to an embodiment of the present disclosure. In this embodiment the sealing washer 140 lacks traction appendages 160. As before, however, the sealing washer 140 includes a sealing portion 142 which may be constructed of rubber or another deformable material and may deform against the valve head 112 and the set screw 120 when compressed to prevent fluid from leaving the thermal expansion valve. In this embodiment the sealing portion 142 may compose the entirety of the sealing washer 140, and the sealing washer 140 may be of a unitary constructed composed of a single material. In one embodiment, the external diameter of the sealing washer 140 may be fifty-sixth hundredths of an inch, while the diameter of the aperture may measure two-hundred and five thousandths of an inch. The preferred embodiment comprises one sealing washer 140; however, in alternate embodiments one or more sealing means may be used.

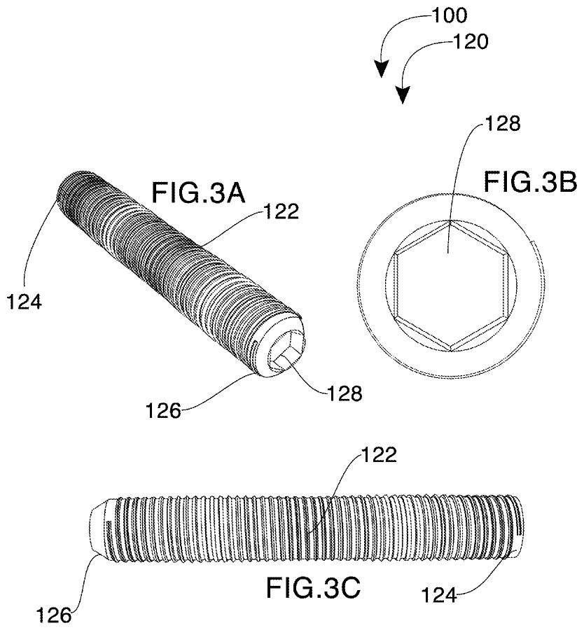

FIGS. 3A-3C are perspective views illustrating the set screw 120 of the manually adjustable thermal expansion valve attachment system according to an embodiment of the present invention. As illustrated, the set screw 120 may include an externally threaded screw shaft 122, a first end 124, and a second end 126. The first end 124 may have a taper to ease installation of the externally threaded screw shaft 122 into an internally threaded aperture, such as that of the valve head 112. The second end 126 may include a tool interface 128. Preferably, the tool interface 128 is a hexagonal aperture which is positioned concentric to the externally threaded screw shaft 122 and is dimensioned to accept a 3/32″ hexagonal drive tool, such as a hex key. However, in various embodiments alternative tool interfaces 122 of varying sizes may be used. For example, cross recess, hexalobular, or flathead interfaces may be used. Preferably, the threading of the set screw 120 is right-hand, and the length of the set-screw is one-and-a-quarter inches. Various embodiments may employ longer or shorter screws.

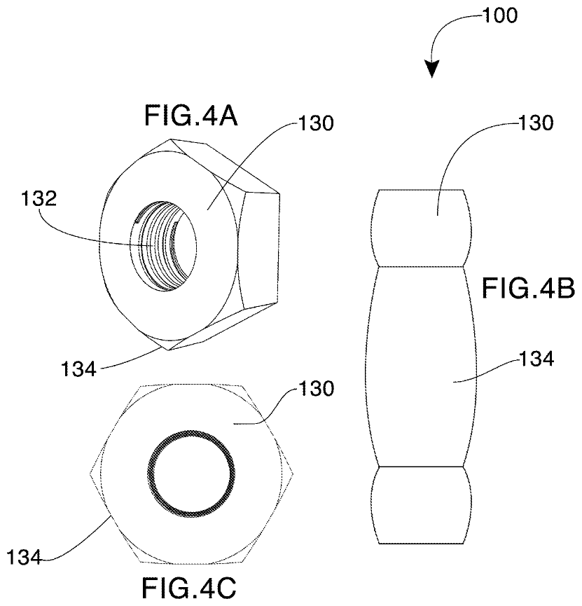

FIGS. 4A-4C show views of the lock nut 130 of the manually adjustable thermal expansion valve attachment system. As shown, the lock nut 130 may include an internally threaded bore 132 and a hexagonal collar 134 which is concentric to the internally threaded bore 132. In some embodiments, the lock nut 130 may include teeth or other traction devices. In a preferred embodiment, the bore 132 includes a #10-32 internal threading. The lock nut 130 may measure one-eighth of an inch in width and three-eighths of an inch in external diameter. In a preferred embodiment the lock nut 130 may measure one-eighth of an inch in height and three-eighths of an inch in diameter.

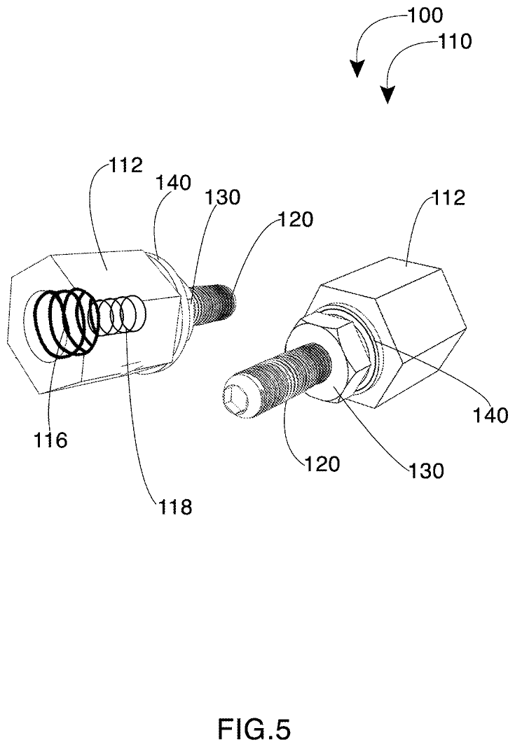

FIG. 5 shows a perspective view of the assembly of the manually adjustable thermal expansion valve attachment system 100 of FIG. 1, according to an embodiment of the present disclosure. As shown, the valve head 112 may comprise a unitary component having a hexagonal collar 114, an internally threaded valve-bore 116, and an internal threaded screw-bore 118. The valve-bore 116 and the screw-bore 118 may be concentric and may comprise a unitary stepped internal bore in combination, enabling the set screw 120 to extend through the entirety of the valve head 112. The valve-bore 116 may be dimensioned and threaded to accept a thermal expansion valve body, whereas the screw-bore 118 may be dimensioned and threaded to accept the disclosed set screw 120. Accordingly, the valve-bore 116 preferably has an 11/16×24 threading. The screw-bore 118 preferably has a #10-32 threading. As shown, the valve-bore 116 may be half of an inch long, while the screw-bore 118 may be three-eighths of an inch long in a preferred embodiment. The overall height of the valve head 112 may be seven-eighths of an inch, and the diameter may be about one inch in the preferred embodiment. Other embodiments for differing sizes of thermal expansion valves may incorporate differing dimensions. The valve head 112, set screw 120, and lock nut 130 may be constructed of aluminum, brass, steel, or other high strength materials in various embodiments.

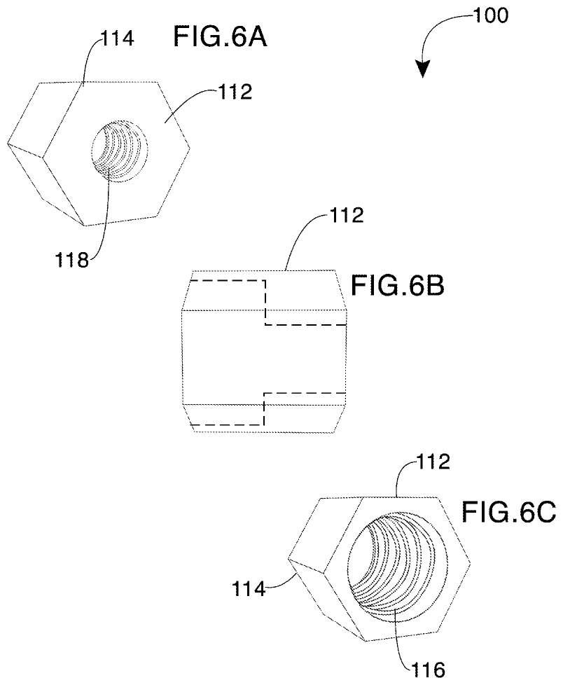

FIG. 6A-6C show various views of the manually adjustable thermal expansion valve attachment system 100 of FIG. 1, according to an embodiment of the present disclosure. As above, the manually adjustable thermal expansion valve attachment system 100 may include the valve head 112 including the unitary component having the hexagonal collar 114, the internally threaded valve-bore 116, and the internal threaded screw-bore 118.

It should be noted that, under appropriate circumstances, considering such issues as design preference, user preferences, marketing preferences, cost, structural requirements, available materials, technological advances, etc., other methods for manually adjustable thermal expansion valve attachment system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A manually adjustable thermal expansion valve attachment system comprising:
an assembly including,
a valve head configured to attach to an existing thermal expansion valve, in place of an expansion bulb head,
a set screw threaded centrally into said valve head,
a lock nut threaded externally onto said set screw, and
a sealing washer configured to seal said set screw to said valve head.

2. The manually adjustable thermal expansion valve attachment system of claim 1, wherein said valve head comprises a hexagonal collar and an interior threaded cylinder configured to engage a thread of said thermal expansion valve.

3. The manually adjustable thermal expansion valve attachment system of claim 2, wherein said valve head includes a threaded aperture concentric to said threaded cylinder.

4. The manually adjustable thermal expansion valve attachment system of claim 3, wherein said set screw is disposed in said aperture and threads in and out within said assembly.

5. The manually adjustable thermal expansion valve attachment system of claim 3, wherein said set screw comprises #10-32 threading.

6. The manually adjustable thermal expansion valve attachment system of claim 1, wherein said sealing washer has a circular profile and a center aperture.

7. The manually adjustable thermal expansion valve attachment system of claim 6, wherein said sealing washer sits between said lock nut and said valve head, such that said sealing washer compresses around said set screw and seals said assembly.

8. The manually adjustable thermal expansion valve attachment system of claim 1, wherein said sealing washer comprises an external lock ring having traction appendages for applying friction to or deforming against both said valve head and said lock nut.

9. The manually adjustable thermal expansion valve attachment system of claim 8, wherein said sealing washer further comprises a sealing-portion disposed interior to said external lock ring.

10. The manually adjustable thermal expansion valve attachment system of claim 1, wherein said sealing-portion comprises a deformable material such that when compressed, said sealing portion deforms to said valve head and said set screw to prevent fluid from leaving said thermal expansion valve upon which said assembly is installed.

11. The manually adjustable thermal expansion valve attachment system of claim 10, wherein said deformable material of said sealing portion includes rubber.

12. The manually adjustable thermal expansion valve attachment system of claim 6, wherein said sealing washer does not comprise traction appendages.

13. The manually adjustable thermal expansion valve attachment system of claim 5, wherein said lock nut comprises an internally threaded bore and a hexagonal collar which is concentric to said internally threaded bore.

14. The manually adjustable thermal expansion valve attachment system of claim 1, wherein said valve head comprises a hexagonal collar, an internally threaded valve-bore, and an internal threaded screw-bore.

15. The manually adjustable thermal expansion valve attachment system of claim 14, wherein said valve-bore and said screw-bore are concentric and disposed around a unitary stepped internal bore, enabling said set screw to extend completely through said valve head.

16. The manually adjustable thermal expansion valve attachment system of claim 15, wherein said valve-bore is dimensioned and threaded to accept a body of said thermal expansion valve, and said screw-bore is dimensioned and threaded to receive said set screw.

17. A manually adjustable thermal expansion valve attachment system, the manually adjustable thermal expansion valve attachment system comprising:
an assembly including,
a valve head configured to attach to an existing thermal expansion valve, in place of an expansion bulb head,
a set screw threaded centrally into said valve head,
a lock nut threaded externally onto said set screw,
a sealing washer configured to seal said set screw to said valve head, and
a valve depressor adaptor;
wherein said valve head comprises a hexagonal collar and an interior threaded cylinder configured to engage a thread of said thermal expansion valve;
wherein said valve head includes a threaded aperture concentric to said threaded cylinder;
wherein said set screw is disposed in said aperture and threads in and out within said assembly;
wherein said sealing washer has a circular profile and a center aperture; and
wherein said sealing washer sits between said lock nut and said valve head, such that said sealing washer compresses around said set screw and seals said assembly.

18. Method of repairing and expansion bulb head comprising:
providing the system of claim 1;
and
attaching the valve head to the threads of operational thermal expansion valve in place of expansion bulb head.

19. The method of claim 18 further comprising adjusting the thermal expansion valve with the set screw.
